(19) United States
(12) Patent Application Publication
(10) Pub. No.: US 2024/0106061 A1
(43) Pub. Date: Mar. 28, 2024

(54) Battery Contact Antenna

(71) Applicant: ZEBRA TECHNOLOGIES CORPORATION, Lincolnshire, IL (US)

(72) Inventors: Chu Pang Alex Ng, Markham (CA); Colin Graham, Toronto (CA)

(21) Appl. No.: 17/953,125

(22) Filed: Sep. 26, 2022

(51) Int. Cl. H01M 50/284; H01M 10/42; H01M 50/213; H01Q 1/22

(52) U.S. Cl. CPC H01M 50/284; H01M 10/425; H01M 50/213; H01Q 1/22; H01M 2220/30

(57) ABSTRACT

Battery pack transmissions are disclosed herein. An example battery pack including at least one battery cell; a radio frequency (RF) chip; a battery contact contacting an end of the at least one battery cell; a first excitor connecting to the battery contact via the first RF port; and a second excitor connecting to the battery contact via the second RF port; wherein: the RF chip determining if the signal is to be transmitted at a first frequency or a second frequency, the RF chip sends the signal to the battery contact via the first excitor, the first excitor resonates at a first transmission frequency and energizes the at least one battery cell and the battery contact at the first frequency for transmission of the signal, and when the signal is transmitting at the second frequency, the RF chip sends the signal to the battery contact via the second excitor.

### BACKGROUND

Mobile device miniaturization presents a plethora of challenges as the amount of space available for components continues to decrease. At the same time, the number of wireless protocols and/or frequency bands supported by mobile devices is increasing, which presents unique challenges with respect to antenna placement and design.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates an example environment of a battery pack in which systems or methods described herein may be implemented.

FIGS. 2a and 2b illustrates a first end and a second end, respectively, housed within the example environment of FIG. 1.

FIG. 3 is a block diagram of an example battery pack for implementing example methods and/or operations described herein.

FIG. 4 is a block diagram of an example radio module as illustrated in FIG. 3.

FIG. 5 illustrates a first end view of the battery pack illustrated in FIG. 1.

FIG. 6 illustrates a detailed view of the first end view of the battery pack as shown in FIG. 4.

FIG. 7 is flowchart of an example process using the example system of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The following detailed description of example implementations refers to the accompanying drawings. The same reference numbers in different drawings may identify the same or similar elements.

Battery packs may contain an antenna mounted within a housing of the battery pack, such that the battery pack is capable of transmitting and receiving data. However, given the size of some battery packs, the size and shape of the antenna is greatly restricted, forcing the antenna to be smaller than desired.

Battery packs often contain battery cells within the battery pack. The battery cells abut battery contacts within the battery pack, where the battery contacts extend from a printed circuit board to the battery cells. By exciting the battery contacts to a transmission frequency, the battery contacts may resonate the battery cells at the same frequency, allowing the battery cells to aid in transmitting a signal.

Examples disclosed herein are directed to a battery pack comprising: at least one battery cell; a printed circuit board (PCB) having a radio frequency (RF) chip, a first RF port, and a second RF port; a battery contact contacting an end of the at least one battery cell, wherein the battery contact is connected to the PCB; a first excitor connecting the PCB to the battery contact via the first RF port; and a second excitor connecting the PCB to the battery contact via the second RF port; wherein: the RF chip processes a signal for transmission at one of a first frequency and a second frequency, when the signal is transmitted at the first frequency, the first RF port receives the signal from the RF chip and sends the signal to the battery contact via the first excitor, the first excitor resonates at the first frequency and energizes the at least one battery cell and the battery contact at the first frequency, and when the signal is transmitted at the second frequency, the second RF port receives the signal from the RF chip and sends the signal to the battery contact via the second excitor, the second excitor resonates at the second frequency and energizes the at least one battery cell and the battery contact at the second frequency.

Other examples disclosed herein are directed to a method comprising: selecting, via a radio frequency (RF) chip, one of a first frequency and a second frequency for transmitting a signal; filtering the signal to the selected transmission frequency; selecting a first RF port associated with the first transmission frequency or a second RF port associated with the second RF transmission frequency; when the first frequency is selected, transmitting the filtered signal via the first RF port, wherein the first RF port is in connection with a battery contact via a first excitor, the first excitor vibrating the battery contact at the first frequency; when the second frequency is selected, transmitting the filtered signal via the second RF port, wherein the second RF port in connection with the battery contact via a second excitor, the second excitor vibrating the battery contact at the second frequency.

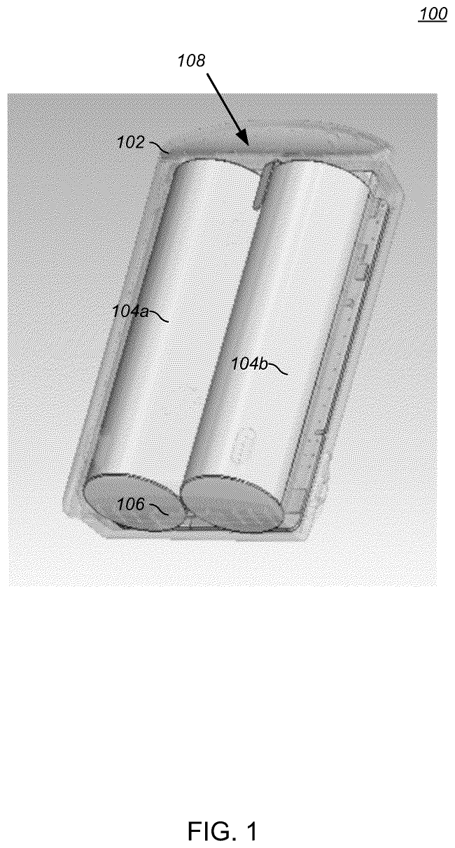

FIG. 1 depicts an example battery pack. The battery pack 100 of FIG. 1 includes a housing 102 containing two battery cells: a first cell 104a and a second cell 104b, also known herewith as battery cells 104 or cells 104. While FIG. 1 depicts two battery cells in the battery pack 100, those skilled in the art know that the battery pack 100 may contain more or less battery cells 104 as required by the battery pack 100. The battery cells 104 have a first end 106 and a second end 108. In some embodiments, the second end 108 is also known as a cathode end and is associated with the positive terminals of the battery cells 104. In some embodiments, the first end 106 is also known as an anode end and is associated with the negative terminals of the battery cells 104.

The battery pack 100 as shown in FIG. 1 is a battery pack that can be used with mobile devices that require a mobile power pack. The battery pack 100 as depicted is designed to be installed within the rear of a mobile device however it should be appreciated that in other embodiments the battery pack 100 can be used in a wide range of devices that require a mobile, rechargeable battery source. As described above, the first end 106 includes a battery contact extending from a printed circuit board (PCB) to the battery cells 104. When transmitting signals, a signal may be sent from the PCB to the battery contact, using the battery contact as an antenna. By designing the antenna such that there are two ports going from the PCB to the battery contact, the battery contact may receive two different signal frequencies and be optimized for transmission along two ultra-wide band (UWB) frequencies, for example.

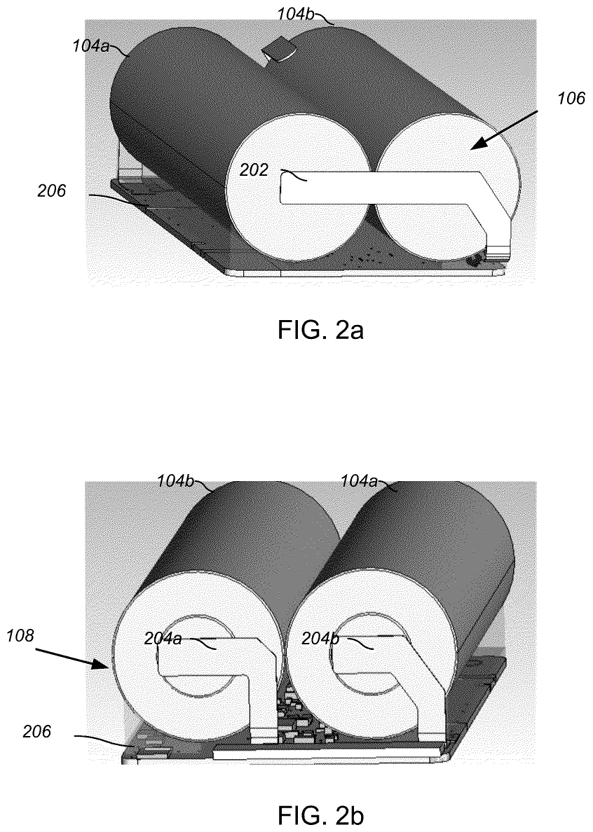

FIGS. 2a and 2b depict the battery cells 104 of FIG. 1, but with the housing 102 removed. FIG. 2a depicts the first end 106 of the battery cells 104 while FIG. 2b depict the second end 108 of the battery cells 104.

As can be seen in FIG. 2a, the first end 106 of the battery cells 104 are adjacent to a first battery contact 202, the first battery contact 202 is also referred to herein as “battery contact”. The battery contact 202 is in electrical contact with the battery cells 104 such that during standard operation of the battery pack 100 in acting as a power source, the battery contact 202 allows energy flow to a device receiving power from the battery pack 100.

As illustrated in FIGS. 2a and 2b, the battery contact 202 is supported by a printed circuit board (PCB) 206. As depicted in FIG. 2a, the battery contact 202 contacts the first end 106 of each of the battery cells 104. The battery contact 202 is made from a conductive material such as that allows current flow within the battery pack 100. In the illustrated embodiment, the battery contact 202 is grounded to promote current flow as a non-grounded battery contact 202 may contribute to interference during signal transmission.

As can be seen in FIG. 2b, the second end 108 of the battery cells 104 contact a second and third contact members 204a and 204b, respectively. In some embodiments, the second and third contacts 204 provide current flow from the positive end of the battery cells 104 to the printed circuit board 206. As depicted in FIG. 2b, each of the second and third battery contact 204 contacts the second end 108 of each of the battery cells 104 separately. The second and third battery contact 204 is made from a conductive material that allows current flow within the battery pack 100.

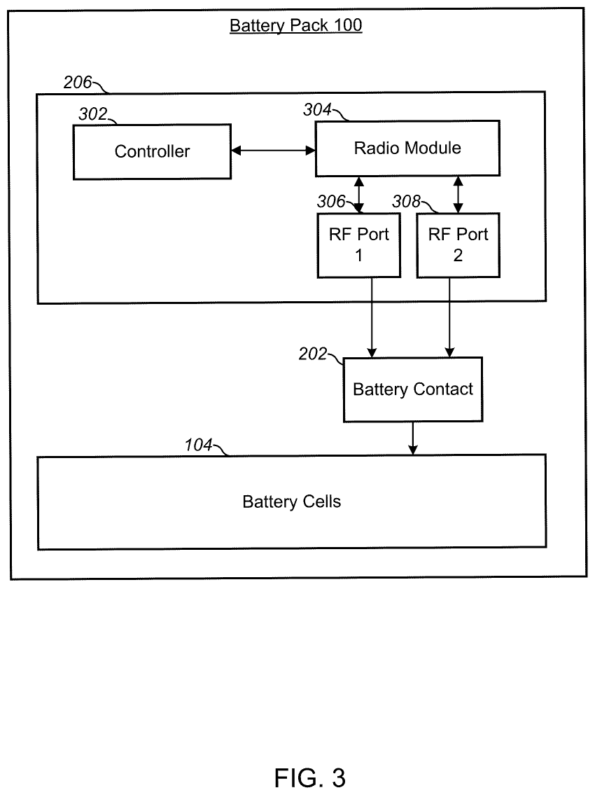

FIG. 3 is a block diagram representative of internal components of the battery pack 100. The block diagram of FIG. 3 depicts the PCB 206 and the battery cells 104.

As illustrated in FIG. 3, the battery pack 100 includes the battery cells 104 and the PCB 206. The battery cells 104 are adjacent to the battery contact 202, the battery contact 202 being connected to the PCB 206 via RF ports 306, 308. In some embodiments, the battery cells 104 abut the battery contact 202.

As illustrated in FIG. 3, a controller 302 mounted on the PCB 206 is in communication with a radio module 304. The radio module 304 will be discussed in further detail below. The controller 302 is a processor that can regulate the operation of the PCB 206.

As illustrated in FIG. 3, the radio module 304 is in connection with a first radio frequency (RF) port 306 and a second RF port 308. The first RF port 306 connects the radio module 304 to the battery contact 202. The second RF port 308 connects the radio module 304 to the battery contact 202. The nature of the connection of the first RF port 306, the second RF port 308, and the battery contact 202 will be discussed in further detail below.

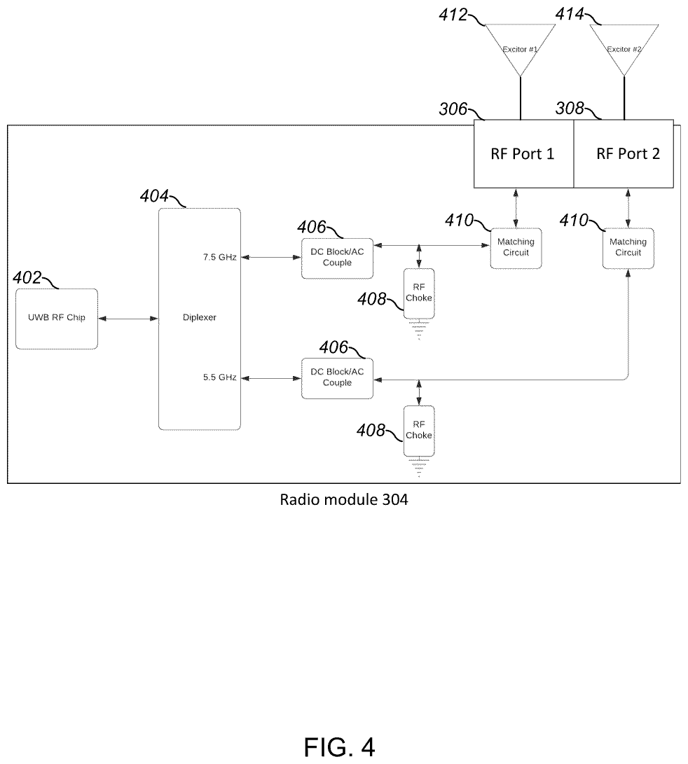

FIG. 4 depicts a component diagram of the radio module 304. The individual components of the radio module 304 work together to generate signals to be transmitted at a particular frequency.

As illustrated in FIG. 4, the radio module 304 includes an ultra-wide band (UWB) radio frequency (RF) chip 402 (or RF chip 402). In the illustrated embodiment, the UWB RF chip 402 generates a signal for transmitting. In other embodiments, the signal may be generated by the controller 302. The RF chip 402 determines a transmission frequency for the signal to be transmitted. The RF chip 402 selects the transmission frequency by selecting the optimal frequency for transmission with respect to signal traffic or other known factors relating to signal congestion. In the illustrated embodiment, the transmission frequency bands are 5.5 GHz, 7.5 GHz, or a combination of the two frequency bands by a process known as frequency hopping.

The selection made by the RF chip 402 proceeds to the diplexer 404 where the diplexer 404 converts the signal from the RF chip 402 to the selected frequency. The diplexer 404 then forwards the converted signal to a DC block/AC couple 406. The DC block/AC couple 406 acts as a capacitor on the converted signal and regulates the voltage of the signal. The signal then passes to the RF choke 408. The RF choke 408 acts as an inductor and blocks high frequency signals while allowing DC signals to pass through. In other embodiments, the RF choke 408 isolates the signal from a ground of the battery pack 100. The position of the RF choke 408 within the radio module 304 allows the DC signals to be grounded while preventing high frequency signals from diverting. The matching circuit 410 regulates the impedance of a signal for optimal power transfer for transmission. Once the signal is past the corresponding matching circuit, the signal passes via the corresponding RF port to either the first excitor 412 or the second excitor 414 dependent upon the selected frequency of the diplexer 404. The first and second excitor operate as the beginning of the antenna elements. The first excitor 412 is attached to the first RF port 306 and the second excitor 414 is connected with the second RF port 308 as is seen in FIG. 3.

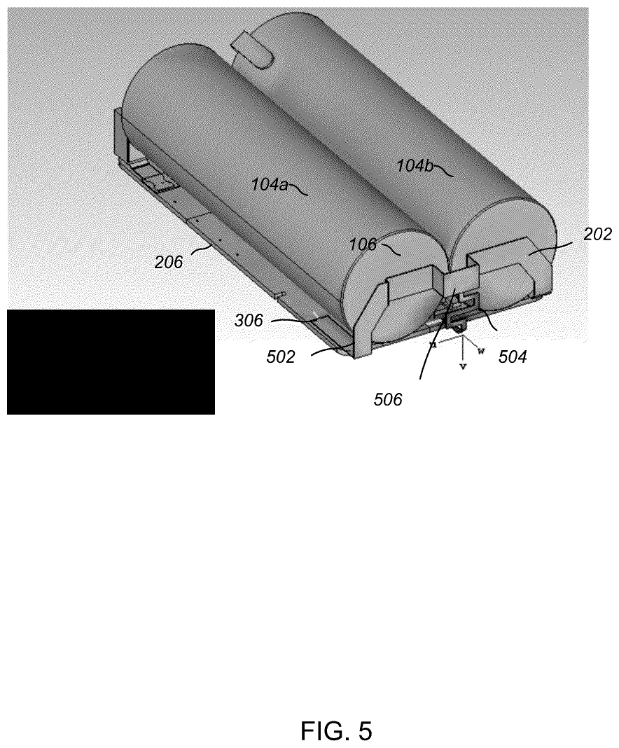

FIG. 5 depicts the first side 106 of the battery cells 104 including a redesigned battery contact 202. As depicted in FIG. 5, the battery contact 202 includes the first excitor 502, the second excitor 504 and an extended area 506. The battery contact will be described in further detail below.

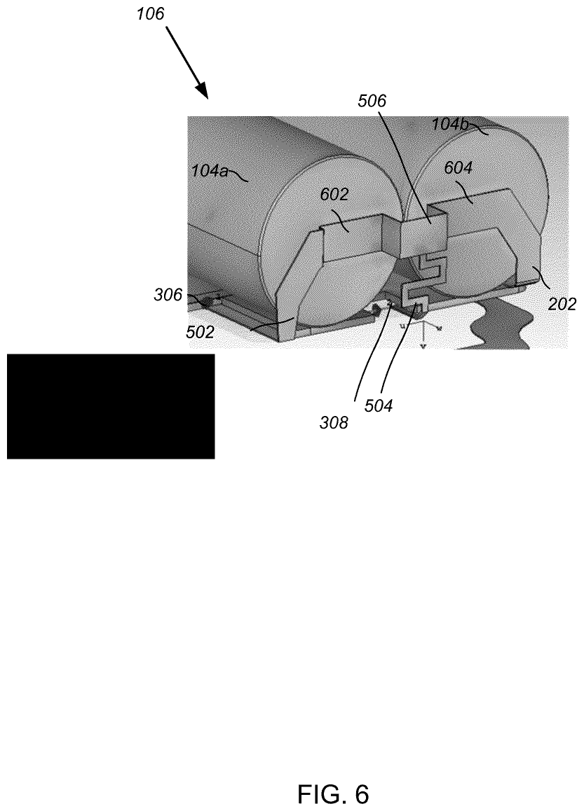

FIG. 6 depicts an enhanced view of the first side 106 of the battery cells 104. The battery contact 202 includes the first excitor 502 and a second excitor 504. The first excitor 502 is interconnected between the PCB 206 via the first RF port 306 and the battery contact 202. The second excitor 504 is interconnected between the PCB 206 via the second RF port 308 and the battery contact 202. The first excitor 502 and the second excitor 504 allow for signals to be transmitted from the respective RF port 306/308 to the battery contact 202 and to the battery cells 104.

The excitors 502/504 as depicted in FIG. 6 are designed such that when the signal with the selected frequency is passed from the respective RF port to the battery contact 202, the signal excites the excitor 502/504 from the RF port to the battery contact 202. As the signal passes along the excitor 502/504 and the battery contact 202, the signal excites the excitor 502/504 and the battery contact 202 and causes the excitor and the battery contact to resonate at a desired transmission frequency. The transmission frequency that the battery contact 202 resonates at is the frequency as selected by the radio module 304 as shown in FIG. 3. The radio module 304 alters the signal to the selected transmission frequency, and then, depending on the selected transmission frequency, the radio module 304 either sends the signal to the battery contact 202 via the first RF port 306 or the second RF port 308. For example, as illustrated in FIGS. 3 and 4, when the selected transmission frequency is 7.5 GHz, the signal is sent through the first RF port 306 and to the first excitor 502 to the battery contact 202. It is important to note that the first excitor 502 and the second excitor 504 are both shaped as such to optimize the resonance of the respective excitor to match the selected transmission frequency. In other words, the first excitor 502 is shaped to optimize resonance for transmission of a 7.5 GHz signal.

As depicted in FIG. 6, while the first excitor 502 is shaped to optimize transmissions of signals at a 7.5 GHz frequency, the second excitor 504 is shaped to optimize the transmission of signals at a 5.5 GHz frequency. To optimize the second excitor 504 for a selected transmission frequency of 5.5 GHz, the second excitor 504 is shaped in a meandering pattern to optimize the length of the second excitor.

As depicted in FIG. 6, as the first excitor 502 and the second excitor 504 resonate at the respective transmission frequency, the battery contact 202 also beings to resonate at the selected transmission frequency. The battery contact 202 includes cell contact areas 602 and 604 where the battery contact 202 comes into close proximity with battery cells 104a and 104b respectively. As the cell contact areas 602 and 604 resonate with the battery contact 202, the battery cells 104a and 104b also resonate. It is important to note, that while FIG. 6 shows two cell contact areas and two battery cells, it should be noted that in other embodiments the count may be more than two each, less than two each or a different amount. In the depicted embodiments, the battery cells 104 comprise a metal exterior housing such that the battery cells 104 properly resonate with the battery contact 202. The battery cells 104, battery contact 202 and the respective first or second excitor all resonate at the same selected transmission frequency which allows the battery cells 104, battery contact 202, and the excitors to act together as an antenna for transmission.

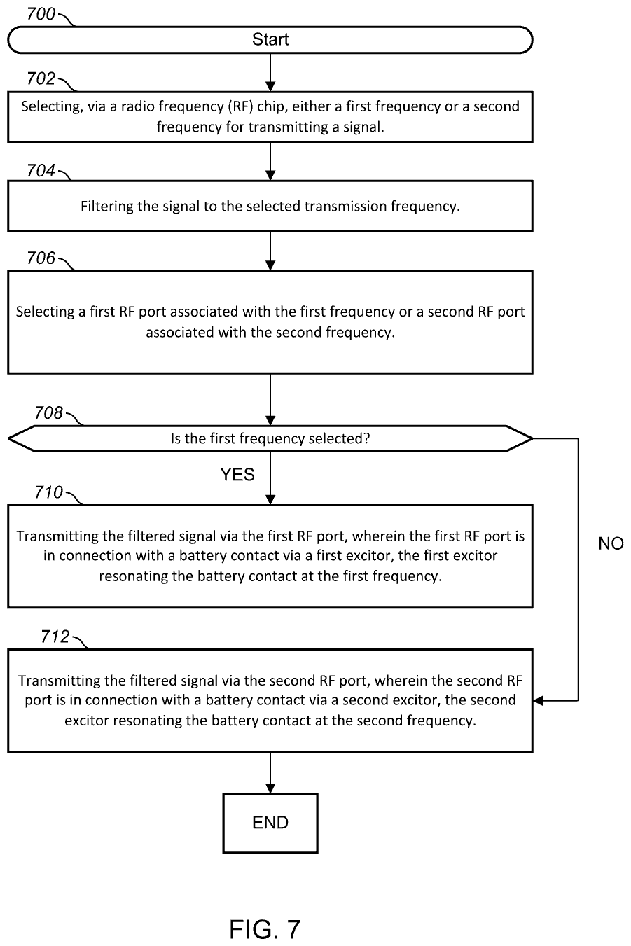

FIG. 7 depicts a flow chart of an example method to complete with the embodiment shown in FIG. 5.

Step 702 includes selecting, via a radio frequency (RF) chip, either a first frequency or a second frequency for transmitting a signal. In the illustrated embodiment, the selection is made by the RF chip 402. In other embodiments, the selection may be made by the controller 302 or by a separate processor located either within the battery pack or external to the battery pack. The frequency may be selected based on processes known in the art including frequency hopping technology. In the illustrated embodiments, the RF chip 402 selects an ultra-wide band frequency.

As illustrated in FIG. 7, step 704 includes filtering the signal to the selected transmission frequency. Once the RF chip 402 selects a transmission frequency, the radio module 304 filters the selected signal such that the signal exits the radio module 304 at the selected transmission frequency. Based on the selected transmission frequency, the signal is either sent to the first RF port 306 or the second RF port 308.

As illustrated in FIG. 7, step 706 includes selecting a first RF port associated with the first transmission frequency or a second RF port associated with the second transmission frequency.

Per step 708, when the first transmission frequency is selected, the process moves to step 710. Step 710 includes transmitting the filtered signal via the first RF port, wherein the first RF port is in connection with a battery contact via a first excitor, the first excitor resonating the battery contact at the first transmission frequency for transmission of the filtered signal. When the battery contact 202 resonates, the battery contact 202 causes the battery cells 104 to also resonate, resulting in a larger antenna capable of emitting a larger radiation pattern when compared to if the battery contact alone was the antenna.

Per step 712, when the first transmission frequency is not selected, then transmitting the filtered signal via the second RF port, wherein the second RF port is in connection with a battery contact via a second excitor, the second excitor resonating the battery contact at the second transmission frequency for transmission of the filtered signal.

When the battery cells 104 receive a signal, the battery cells 104 can receive the signal and resonate at the received frequency. When the received frequency matches either of the frequencies to which the excitors are optimized, then the respective excitor of the received frequency resonates and optimizes the receiving of the signal at the respective RF port. In other words, when the battery cells 104 receive a signal with at a frequency of 7.5 GHz, the battery cells 104 resonate at 7.5 GHz, which causes the battery contact 202 to resonate at 7.5 GHz and then the first excitor 502 to resonate at 7.5 GHz. When the system is all resonating at 7.5 GHz, the system is in an optimal state to receive a signal of 7.5 GHz at the first RF port via the first excitor 502.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A battery pack comprising:
at least one battery cell;
a printed circuit board (PCB) having a radio frequency (RF) chip, a first RF port, and a second RF port;
a battery contact contacting an end of the at least one battery cell, wherein the battery contact is connected to the PCB;
a first excitor connecting the PCB to the battery contact via the first RF port; and
a second excitor connecting the PCB to the battery contact via the second RF port;
wherein:
the RF chip processes a signal for transmission at one of a first frequency and a second frequency,
when the signal is transmitted at the first frequency, the first RF port receives the signal from the RF chip and sends the signal to the battery contact via the first excitor, the first excitor resonates at the first frequency and energizes the at least one battery cell and the battery contact at the first frequency, and
when the signal is transmitted at the second frequency, the second RF port receives the signal from the RF chip and sends the signal to the battery contact via the second excitor, the second excitor resonates at the second frequency and energizes the at least one battery cell and the battery contact at the second frequency.

2. The battery pack of claim 1, wherein the at least one battery cell resonates at a same frequency as the battery contact.

3. The battery pack of claim 1, wherein:
the first excitor has a first length;
the second excitor has a second length; and
the second length is different than the first length.

4. The battery pack of claim 3, wherein the first length corresponds to a first signal wavelength associated with the first frequency and the second length corresponds to a second signal wavelength associated with the second frequency.

5. The battery pack of claim 1, wherein the battery contact contacts a negative end of the battery cell.

6. The battery pack of claim 1, wherein the signal is an ultra-wide band signal.

7. The battery pack of claim 1, wherein the RF chip determines whether the signal is one of the first frequency and the second frequency based on bandwidth of traffic.

8. The battery pack of claim 1, wherein the RF chip selects the first frequency and the second frequency in sequence to transmit the signal.

9. The battery pack of claim 1, wherein the first frequency is 7.5 GHz and the second frequency is 5.5 GHz.

10. A method comprising:
selecting, via a radio frequency (RF) chip, one of a first frequency and a second frequency for transmitting a signal;
filtering the signal to the selected transmission frequency;
selecting a first RF port associated with the first transmission frequency or a second RF port associated with the second RF transmission frequency;
when the first frequency is selected, transmitting the filtered signal via the first RF port, wherein the first RF port is in connection with a battery contact via a first excitor, the first excitor vibrating the battery contact at the first frequency;
when the second frequency is selected, transmitting the filtered signal via the second RF port, wherein the second RF port in connection with the battery contact via a second excitor, the second excitor vibrating the battery contact at the second frequency.

11. The method of claim 10, wherein the first excitor has a first shape and the second excitor has a second shape different from the first shape.

12. The method of claim 11, wherein the first shape and the second shape optimize the transmission at the first frequency and the second frequency, respectively.

13. The method of claim 10, wherein the battery contact abuts at least one battery cell, the at least one battery cell resonating with the battery contact at the selected transmission frequency.

14. The method of claim 10, battery pack of claim 1, wherein the battery contact contacts a negative end of the battery cell.

15. The method of claim 10, wherein the filtered signal is an ultra-wide band signal.

16. The method of claim 10, wherein the RF chip determines if the signal is the first transmission frequency or the second transmission frequency based on bandwidth of traffic.

17. The method of claim 10, wherein the RF chip selects both the first transmission frequency and the second transmission frequency to transmit the signal in sequence.

18. The method of claim 10, wherein the first transmission frequency is 7.5 GHz and the second transmission frequency is 5.5 GHz.
